(19) United States
(12) Patent Application Publication
(10) Pub. No.: US 2007/0025178 A1
(43) Pub. Date: Feb. 1, 2007

(54) Pigment dispersions and preparation method thereof

(75) Inventors: Sheau Van Kao, Oakville (CA); Shigang Qiu, Toronto (CA); Tie H. Ng, Mississauga (CA); John Abate, Mississauga (CA)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/190,001

(22) Filed: Jul. 27, 2005

(51) Int. Cl. B01F 15/02; C09D 11/00

(52) U.S. Cl. 366/136; 366/137; 106/31.65; 106/31.9

(57) ABSTRACT

A pigment dispersion process includes providing a solution in a dispersion apparatus tha includes a container, a rotor-stator type homogenizer and a recirculation device. The process includes adding pigment particles to the solution to form a dispersion, flowing at least a portion of the dispersion to the homogenizer via the recirculation device, reducing a size of the pigment particles using the homogenizer, and recirculating the dispersion between the container and the homogenizer via the recirculation device. The dispersion system may include a container containing a dispersion that may contain an amount of deionized water, an amount of surfactant and an amount of pigment, and a recirculation device coupled to the container and to a rotor-stator homogenizer that allows the dispersion to flow between the container and the homogenizer.

### BACKGROUND

Toners, for use in printers, copiers, and the like, may be prepared by existing mechanical reduction processes, such as a conventional styrene acrylate copolymer based toner process. In such a process, the copolymer resin is melt kneaded or extruded with a pigment, pulverized and classified to provide toner particles of the desired volume average particle diameter and size distribution.

As an improvement to the foregoing mechanical reduction processes, other processes are known in which toner is achieved via aggregation as opposed to particle size reduction. For example, in chemical aggregation processes, toner may be formed chemically in situ and does not require known pulverization methods. Chemical aggregation processes typically involve the formation of an emulsion latex of the resin particles, in which particles have a small size of, for example, from about 5 nanometers to about 500 nanometers in diameter, by heating the resin in water, or by making a latex in water using an emulsion polymerization method. A colorant dispersion of a pigment dispersed in water may also be separately formed. The colorant dispersion is added to the emulsion latex mixture, and an aggregating or complexing agent is then added to form aggregated toner particles. The aggregated toner particles are then heated to enable coalescence or fusing, thereby achieving aggregated, fused toner particles.

The pigment dispersion is an important component in the preparation of chemically aggregated toner. In order for the pigment particles to form aggregates with the latex particles, the pigment particles should have size smaller or at least a size comparable to the latex particles, preferably between about 5 and 300 nanometers in diameter, and more preferably between about 5 and 150 nanometers in diameter. There are several well-known methods to prepare pigment dispersions with a particle size less than about 150 nanometers in diameter. For example, U.S. Pat. No. 5,026,427 teaches the use of a liquid jet interaction apparatus, such as a microfluidizer, to prepare pigment dispersion for use in ink jet inks. U.S. Pat. No. 5,085,698 teaches the preparation of pigment dispersions using a media mill, a ball mill, an attritor, or a liquid jet interaction apparatus. However, media mill and ball mill are known to generate contaminants from the media-media impaction, and the liquid jet interaction apparatus is prone to mechanical breakdown as a result of high application pressure.

Rotor-stator type homogenizers have been widely used to prepare emulsions and dispersions. However, the particle size achievable with rotor-stator homogenizers is not as small as those with media mills or high pressure homogenizers equipped with homogenizing valves or liquid jet interaction chambers.

A recirculation mode of operating a rotor-stator type of homogenizer can be illustrated by FIG. 1. In FIG. 1, a vessel 2 is operatively coupled to a mixer 6 via a liquid circulation network 8 that may include a mechanical pump to facilitate liquid circulation. The mixer 6 is generally a container that contains a rotating stirring device. The vessel 2 initially contains a mixture of pigment particles dispersed in a solvent such as, for example, water, and possibly a surfactant is equipped with a stirring device 10 (depicted as agitator blades) and a valve 12. During operation, the valve 12 is opened to allow a portion of the mixture to flow from the vessel 2 to the mixer 6. The post-mixer circulating composition returns to the vessel 2 via the liquid circulation network 8. The mixer may be an in-line rotor-stator type homogenizer with a set of rotor-stator elements that may be arranged to provide more intensive mixing. The rotor-stator elements may be provided as supercoarse, coarse, medium, fine, superfine and neutral. The rotor-stator elements may provide more intensive mixing as they become finer. A combination of rotor-stator elements may be used. For instance, in the order of entrance into the homogenizer, the combination may be coarse, fine and superfine rotor-stator elements.

### SUMMARY

Particle reduction processes are currently available, such as, for example, media mills, micro-fluidization or high-pressure homogenization. However, these processes have limitations in capacity, can introduce unnecessary contaminants, have generally a high capital cost, or may be prone to mechanical breakdown.

Exemplary embodiments of methods provide a solution in a dispersion apparatus that includes a container and a rotor-stator type homogenizer that are operatively coupled via a recirculation device. The process may include adding pigment particles to the solution to form a dispersion, flowing the dispersion to the rotor-stator type homogenizer via the recirculation device, reducing a pigment particle size of the dispersion using the homogenizer, and recirculating the dispersion having reduced pigment particle size via the recirculation device.

Also, various exemplary embodiments of systems provide a solution that includes a container containing an amount of deionized water and an amount of surfactant stirred by a stirrer, an amount of pigment added to the water and the surfactant to form a dispersion, and a recirculation device operatively coupled to the container and to a rotor-stator homogenizer that allows the dispersion to flow between the container and the homogenizer repeatedly.

Finally, various exemplary embodiments provide a device for preparing a pigment dispersion system that includes a device for providing a solution in a dispersion apparatus that comprises a container, a rotor-stator type homogenizer and a recirculation device, a device for adding a pigment to the solution to form a dispersion, a device for flowing at least a portion of the dispersion to the homogenizer via the recirculation device, a device for reducing a size of the pigment particles using the homogenizer, and a device for recirculating the dispersion between the container and the homogenizer via the recirculation device.

### BRIEF DESCRIPTION OF THE DRAWINGS

Various exemplary embodiments of the systems and methods of this invention will be described in detail, with reference to the following figures, wherein:

FIG. 1 illustrates a related art equipment for manufacturing a pigment dispersion;

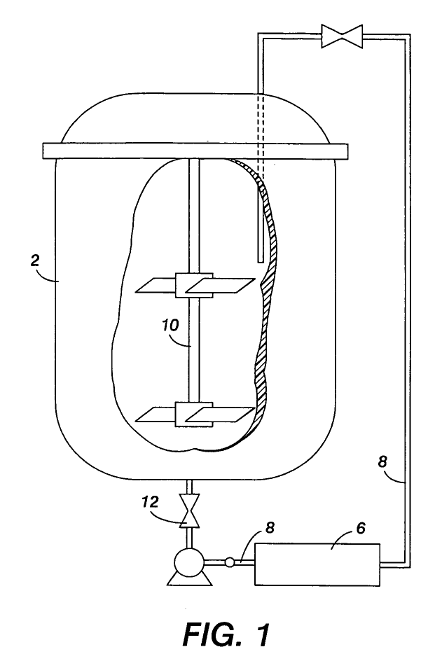

FIG. 2 is an illustration of an exemplary system for preparing a pigment dispersion;

FIG. 3 is a plot illustrating the particle size as a function of the solid pigment concentration, produced with an in-line homogenizer;

FIG. 4 is a flow chart illustrating an exemplary method of preparing a pigment dispersion; and

FIG. 5 is a plot illustrating the particle size obtained for a dispersion produced with an in-line homogenizer and with a batch process.

### DETAILED DESCRIPTION OF EMBODIMENTS

These and other features and advantages of this invention are described in, or are apparent from, the following detailed description of various exemplary embodiments.

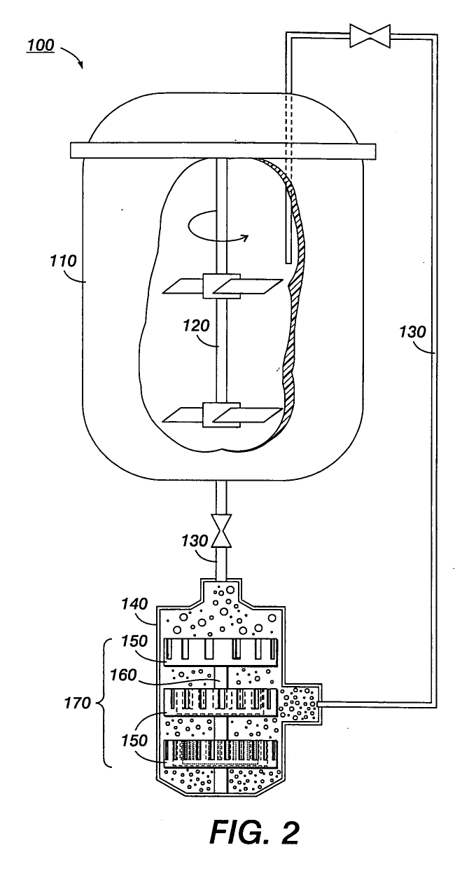

FIG. 2 is an illustration of an exemplary system 100 for preparing a pigment dispersion. In FIG. 2, a first container 110 can contain a solution that may be stirred by a stirring device 120 such as, for example, a stirring blade. The first container 110 is connected to a second container 140 via a recirculation device 130 such as, for example, a tube. The second container 140 contains a rotor-stator type homogenizer 170 that is composed of a rotor 160 and a stator 150.

During operation, a solution containing a solvent such as, for example, water, and a surfactant, may be mixed in the first container 110 using the stirring device 120. Also, a pigment may be added to the first container 110 while the solution is being stirred to form a dispersion. As shown, the first container 110 may be operatively coupled to a second container 140 via a recirculation device 130. A valve may be located at a portion of the liquid circulation network 130 to regulate the flow of the dispersion to the second container 140 or through the recirculation device 130. The liquid circulation network 130 may include a tube that allows the dispersion to flow through the network 130. The second container 140 may contain a rotor-stator homogenizer 170 composed of a stator 150 and a rotor 160, and the dispersion may flow through the liquid circulation network 130 to the second container 140.

According to various exemplary embodiments, the dispersion is flowed to the rotor-stator homogenizer 170. For example, the dispersion may be flowed in the space between the rotor 160 and the stator 150, where the dispersion may be further subjected to the action of the rotor-stator homogenizer 170. When in the rotor-stator homogenizer 170, the pigment particles in the dispersion may be further reduced in size because of the action of the rotor-stator homogenizer 170. According to various exemplary embodiments, the pigment particle size may be reduced to below 150 nm.

After the dispersion passes through the rotor-stator type homogenizer 170, the dispersion may be flowed back to the first container 110 via the liquid circulation network 130. Accordingly, the dispersion may be further stirred by the stirring device 120, and may repetitively be flowed back via the liquid circulation network 130 to the second container 140 and the rotor-stator homogenizer 170, where the dispersion may be further subjected to the action of the rotor-stator homogenizer 170. Also, the dispersion coming out of the rotor-stator type homogenizer 170 may be flowed to another container for further processing that is different from the first container 110, before being recirculated back again into the second container 140 to be subjected further to the action of the rotor-stator type homogenizer 170.

During operation, a solution that may contain water and a surfactant may be provided in a first container 110. The solution may include deionized water, and the surfactant may be, for example, Neogen R-K. The solution may be mixed in the first container 110. For example, 776 g of deionized water and 24 g of Neogen R-K may be mixed until Neogen R-K is completely dissolved. A pigment that includes pigment particles such as, for example, carbon black Regal 330, may be added to the solution to form a dispersion. Also, the dispersion may then be flowed to the rotor-stator homogenizer 170 enclosed in the second container 140 via the recirculation device 130 where it may be subjected to the action of the rotor-stator type homogenizer 170. The dispersion may be subjected to the action of the rotor-stator homogenizer 170 for a period of up to about 75 minutes. Also, the rotor-stator homogenizer 170 may be rotating at a speed of about 7000 revolutions per minute (rpm) to reduce pigment particle size.

Furthermore, the dispersion that has been subjected to the action of the rotor-stator homogenizer may be flowed back to the first container 110 or to another container different than the first container 110, and then flowed back again to the rotor-stator homogenizer 170 via the recirculation device 130. According to various exemplary embodiments, a recirculation loop may be set up by having a discharge outlet in the second container 140 that contains the rotor-stator homogenizer 170. Pipes may be connected between the discharge outlet of the second container 140 and the first container 110 via the recirculation device 130. The first container 110 may be connected to the second container 140 in such a way that the dispersion in the homogenizer 170 may flow to the first container 110 and back to the homogenizer 170 in a substantially continuous manner. Pipes may also be connected between the discharge outlet of the second container 140 and another container different than the first container 110 via the recirculation device 130. The recirculation of the dispersion back to the rotor-stator type homogenizer 170 allows the homogenizer to further reduce the size of the pigment particles dispersed in the dispersion each time the dispersion is recirculated in the homogenizer 170. According to various exemplary embodiments, the size of the pigment particles may be reduced to below 150 nm.

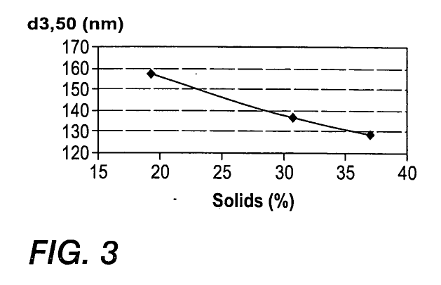

According to various exemplary embodiments, the amount of solid pigment mixed in the solution to form the dispersion may be 20% or more based on the combined total weight. A smaller particle size of the solid pigment is generally obtained with higher concentrations of solid pigment in the dispersion as illustrated in FIG. 3. FIG. 3 is a plot illustrating the particle size as a function of the solid pigment concentration, produced with an in-line homogenizer. Therefore, a method is provided here where the final pigment particle size can be controlled by the pigment concentration. For the smallest possible pigment particle size, pigment concentration greater than 35% by weight is preferred. Very small pigment particles may be obtained by operating the rotor-stator type homogenizer in a recirculation mode, and by formulating the pigment dispersion with high pigment concentrations.

Because there may be some heating in the second container 140 caused by the homogenizer, and the water temperature may be increased by more than 5° C. in the second container 140 when the homogenizer is on. Cascade control may be used to control the reactor temperature and prevent any excessive heating.

According to various exemplary embodiments, various suitable pigments may be employed in dispersions of the present invention, including, but not limited to, carbon black, such as REGAL 330 carbon black, acetylene black, lamp black, aniline black, Chrome Yellow, Zinc Yellow, SICOFAST Yellow, SUNBRITE Yellow, NOVAPERM Yellow, Chrome Orange, Cadmium Red, LITHOL Scarlet, HOSTAPERM Red, FANAL PINK, HOSTAPERM Pink, LITHOL Red, RHODAMINE Lake B, Brilliant Carmine, HELIOGEN Blue, HOSTAPERM Blue, PV Fast Blue, CINQUASIA Green, HOSTAPERM Green, and mixtures thereof.

Illustrative examples of suitable known surfactants or stabilizers selected for the process of the present invention include alkyl sulphates such as sodium dodecyl sulphate and sodium laural sulphate, alkyl benzene sulphonates such as sodium dodecylbenzene sulphonate, commercially known as Neogen R-K, Rhodacal DS-10 and Taycapower BN2060, etc., alkyl phenyloxide sulphonates such as sodium dodecylphenyloxide sulphonate, and the like. The concentration of surfactant in the aqueous phase depends on the type of surfactant and the pigment. A typical surfactant to pigment weight ratio may range from about 3% to 30%, although ratios outside of this range are also possible.

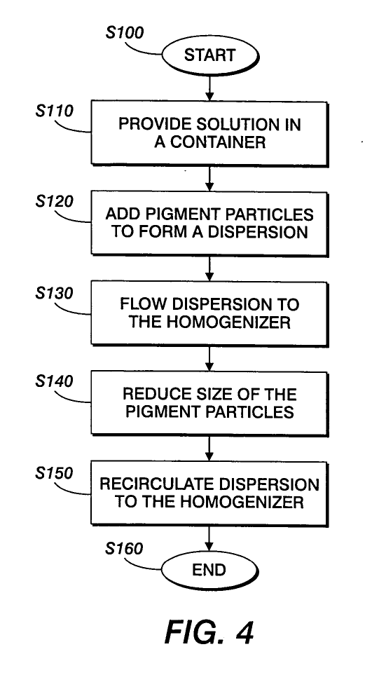

FIG. 4 is a flow chart illustrating an exemplary method of preparing a pigment dispersion. In FIG. 4, the method starts in step S100, and continues to step S110, in which a solution, for example, surfactant dissolved in water, may be provided. According to various exemplary embodiments, the solution may be stirred. Next, control continues to step S120, in which a pigment may be added to the solution to form a dispersion. Next, control continues to step S130, in which the dispersion may be flowed to a rotor-stator homogenizer. The solution may be flowed to the rotor-stator homogenizer before the pigment is added to the solution to form the dispersion. Next, control continues to step S140, in which the action of the rotor-stator homogenizer on the dispersion results in a reduction in the size of the pigment particles. Next, control continues to step S150, in which the dispersion, after being subjected to the action of the homogenizer and after coming out of the homogenizer, is recirculated back into the homogenizer to be further subjected to the action of the homogenizer. Next, control continues to step S160, where the method ends.

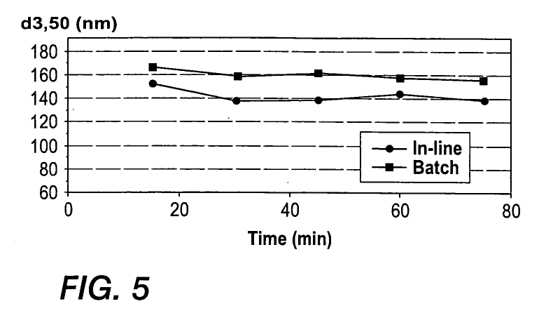

FIG. 5 is a plot that compares the particle size obtained for a dispersion produced by an in-line homogenizer versus a dispersion produced by a batch process. In FIG. 5, the measured pigment particle size, in terms of the volume median diameter d_{3,50}, is plotted as a function of dispersion time, for both the batch process and the inline process. The batch process was performed using a two-liter beaker with 776 g of deionized water and 24 g of surfactant Neogen R-K. The content of the beaker was stirred until the surfactant was completely dissolved in the water to give a clear solution. Then 200 g of carbon black Regal 330 was added to the beaker and a spatula was used to incorporate the carbon black powder to the solution. The beaker was then placed under a batch rotor-stator type homogenizer at a rotational speed of 7000 revolutions per minute (rpm) for 75 minutes. Samples were drawn from the dispersion every 15 minutes. The plot in FIG. 5 shows the measured particle diameter obtained by batch homogenization, plotted as squares, as a function of homogenization time.

For the inline homogenization process, a recirculation loop was added to an in-line homogenizer, and a two-liter beaker with a bottom discharge outlet. Plastic tubings were connected in such a fashion that liquid in the beaker would pass through the inline homogenizer repeatedly. Using another two-liter beaker, 776 g of deionized water and 24 g of Neogen R-K surfactant were mixed until the surfactant completely dissolved. The solution was then added to the beaker and the inline homogenizer turned on. Then, 200 g of carbon black Regal 330 was slowly added to the beaker, and the rotational speed of the homogenizer slowly increased to 7000 rpm for 75 minutes. samples were drawn every 15 minutes. It is clear from FIG. 5 that the in-line homogenizer produces smaller pigment particles compared to the batch process.

It will be appreciated that variants of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A pigment dispersion preparation process, comprising:
providing a solution in a dispersion apparatus that includes a container and a rotor-stator type homogenizer that are coupled via a recirculation device;
adding pigment particles to the solution to form a dispersion;
flowing the dispersion to the rotor-stator type homogenizer via the recirculation device;
reducing a pigment particle size of the dispersion using the homogenizer; and
recirculating the dispersion having reduced pigment particle size via the recirculation device.

2. The process of claim 1, providing the solution further comprising:
providing an amount of deionized water; and
adding an amount of surfactant to the water.

3. The process of claim 1, adding the pigment particles further comprising:
adding an amount of carbon black to the solution to form the dispersion.

4. The process of claim 1, adding the pigment particles further comprising:
adding more than about 20% by weight of pigment to the solution to form the dispersion.

5. The process of claim 1, adding the pigment particles further comprising:
adding about 35% or more by weight of pigment to the solution to form the dispersion.

6. The process of claim 1, wherein:
providing the solution includes providing an amount of deionized water and adding about 2.4% of surfactant to the water; and
adding a pigment to the solution includes adding about 20% of pigment to the solution.

7. The process of claim 1, reducing the size of the pigment particles using the homogenizer further comprising reducing the size of the pigment particles to about 150 nm.

8. The process of claim 2, adding an amount of surfactant further comprising adding an anionic surfactant.

9. The process of claim 3, adding an amount of carbon black to the solution further comprising adding an amount of carbon black Regal 330 to the solution.

10. The process of claim 1, reducing a size of the pigment particles using the homogenizer further comprising recirculating the dispersion 20 or more times.

11. A dispersion system, comprising:
a container containing an amount of deionized water and an amount of surfactant;
an amount of pigment added to the water and the surfactant to form a dispersion; and
a recirculation device coupled to the container and to a rotor-stator homogenizer that allows the dispersion to flow between the container and the homogenizer.

12. The dispersion of claim 11, pigment content of the dispersion being in the range of about 30% to 35% by weight.

13. The dispersion of claim 11, the pigment content of the dispersion being more than about 20% by weight.

14. The dispersion of claim 11, wherein:
the amount of surfactant is about 2.4% the amount of dispersion; and
the amount of pigment is about 20% the amount of dispersion.

15. The dispersion of claim 11, the recirculation device further comprising a tube that allows the dispersion to flow between the homogenizer and the container.

16. The dispersion of claim 11, the dispersion further comprising pigment particles with a size of about 150 mn.

17. An apparatus for preparing the pigment dispersion system of claim 11, comprising:
means for providing a solution in a dispersion apparatus that comprises a container, a rotor-stator type homogenizer and a recirculation device;
means for adding a pigment to the solution to form a dispersion;
means for flowing at least a portion of the dispersion to the homogenizer via the recirculation device;
means for reducing a size of the pigment particles using the homogenizer; and
means for recirculating the dispersion between the container and the homogenizer via the recirculation device.
